(19) United States
(12) Patent Application Publication
(10) Pub. No.: US 2007/0158194 A1
(43) Pub. Date: Jul. 12, 2007

(54) Process for the Production of Contaminant-Free Electrodialyzed Products

(76) Inventors: Richard H. Lincourt, Mundelein, IL (US); Colin P. Crowley, Wheeling, IL (US); Jamie A. Hestekin, Fayetteville, AR (US); Erik K. Whalen-Pedersen, Spring Grove, IL (US)

Correspondence Address: FITCH EVEN TABIN & FLANNERY, 120 S. LASALLE STREET, SUITE 1600, CHICAGO, IL, 60603-3406, US

(21) Appl. No.: 11/617,988

(22) Filed: Dec. 29, 2006

Related U.S. Application Data
(63) Continuation-in-part of application No. 10/784,404, filed on Feb. 23, 2004.

(51) Int. Cl. B01D 61/42

(52) U.S. Cl. 204/518

(57) ABSTRACT

An electrodialysis system is used to produce reliably, contaminant-free electrodialyzed compositions. A feed stream containing an aqueous solution that has contaminants present is contacted with a membrane electrodialysis system and an electrical potential is applied in an amount effective for recovering the desired aqueous solution without the contaminants while maintaining a higher hydrostatic pressure on the product stream or recovery side.

The present application is a continuation-in-part application of U.S. patent application Ser. No. 10/784,404, filed Feb. 23, 2004, which is hereby incorporated by reference.

The present invention is directed to methods for treating aqueous solutions using electrodialysis to provide electrodialyzed compositions which are reliably free of microbial, proteinaceous or certain other contaminants even in the event of a membrane leakage or power loss. More specifically, the electrodialysis system utilizes combinations of semi-permeable, ion selective membranes under the influence of an applied moderate electrical field and maintains a higher hydrostatic pressure on the product side of the electrodialysis membrane than on the feed or inlet side to provide a contaminant-free electrodialyzed composition. The aqueous feed solution is contacted with a membrane electrodialysis system which is effective for providing an electrodialyzed composition having a raised or lowered pH, and/or reduced organic/inorganic anion and/or cation concentrations. In this manner, if leakage through or around the membrane or seals occur, it will leak from the product side to the feed side, thus precluding the passage of microbial, proteinaceous, or certain other contaminants into the product.

### BACKGROUND

The process of electrodialysis (ED) is well known and often utilized for the removal of ionic (or charged) materials from a feed stream, such as a fermented sugar solution or a solution of valuable chemicals that have been contaminated with other ions that render it less valuable or useless. Electrodialysis can be used to either reduce the concentration of an objectionable material in a stream, or to recover and concentrate a desirable material from a contaminated or mixed feed stream. In the latter case, it may be required that the resulting concentrate or product stream be substantially free of certain of the contaminants in the feed stream (for example, pathogenic bacteria, carbohydrates, or allergenic proteins). Under typical operating conditions, this can be assumed to be the case. However, leakage may sometimes occur between the feed and concentrate streams due to wear, improper assembly, or catastrophic failure of either the membranes, seals, or fittings. If leakage through the electrodialysis membranes, seals, or fittings should occur between the feed stream and the product stream, it is possible that critical contamination may occur and go unnoticed.

Equally well-known are design and operating controls used in dairy high-temperature short-time pasteurizers incorporating milk-to-milk heat regeneration, which regulate the pressures and flows of the feed and product streams in such a way as to positively preclude contamination of pasteurized milk (product stream side) with unpasteurized (raw) milk (feed stream side).

This invention incorporates these design principles to provide a process to prevent contamination of electrodialyzed products due to leakage. This will make it possible, for example, to isolate and produce valuable non-allergenic food ingredients from a feed stream containing known allergens, or recover a valuable ionic component from a contaminated solution where the recovered component must be absolutely free of both other ionic and non-ionic feed stream materials.

### SUMMARY

The present invention is directed to a process that provides a means to produce electrodialyzed products (e.g., organic acids, bases, salts, or other useful products made or concentrated by electrodialysis) that are reliably free of microbial, proteinaceous, or certain other contaminants, even in the event of power loss or leakage through membranes, seals, or fittings. The process is carried out using conventional electrodialysis equipment modified by the addition of devices to create and maintain at all times a greater hydrostatic pressure on the product side of the electrodialysis membranes than on the feed, or inlet, side of the membranes. In this manner, leakage through or around the membranes, seals, or fittings, whether or not material is flowing through the membrane assembly, will be from the product side to the feed side, thus significantly reducing or eliminating the risk of passage of microbial, proteinaceous, or certain other contaminants into the product stream.

The electrodialysis (ED) method provided by the present invention includes contacting an aqueous solution with a membrane electrodialysis system. The membrane system includes a cationic and an anionic membrane with the membranes disposed between a cathode electrode and an anode electrode (i.e., an “ED stack”). A lower hydrostatic pressure is maintained on the feed stream side and a higher hydrostatic pressure is maintained on the product side.

In one aspect of the invention, the pressure is controlled by maintaining a lower pressure on the feed stream side using a combination of feed and product pump positionings such that the feed pump is located downstream of the ED unit, the ED unit is located downstream of the product pump, an anti-siphon valve is located on the feed stream side between the ED unit and the feed pump, and the anti-siphon valve is open to the atmosphere when de-energized. The product stream side maintains a positive pressure relative to the feed stream side.

In another aspect of the invention, the pressure is controlled by a differential pressure control device which in turn controls the feed pump and the product (concentrate) pump. The differential pressure control device controls the pumping speed on the feed and/or product stream sides to control the pressures and to maintain a positive relative pressure on the product stream side.

In yet another aspect of the invention, the pressure is controlled by a pressure control valve that is located on the product/concentrate line in a position downstream of the ED stack. This pressure control valve is controlled by a differential pressure control device which opens or closes the valve to maintain a positive relative pressure on the product/concentrate stream side.

In all aspects of the invention, the feed tank overflow is located such that it is lower than the lowest level of product in the system, and the product (concentrate) tank outlet is located such that it is higher than the highest level of the feed stream in the system, thus ensuring that the hydrostatic pressure of the product stream will be greater than that of the feed stream in the event of the loss of motive or electrical power.

Many types of aqueous solutions may be treated using the ED method of the invention, such as, but not limited to, acids, bases, salts, fermentates, reaction mixtures, brines, extracts, among others. In one aspect, a solution of bacteria-contaminated water may be treated to extract table salt which is safe for consumption. In another aspect, a solution of cheese whey fermented to produce lactic acid and neutralized with sodium hydroxide may be treated to produce lactic acid which is free from whey protein (an allergen). Generally, any solution which contains ionized constituents and a constituent which is undesirable in the product may be treated using the ED method of the invention.

### BRIEF DESCRIPTION OF THE DRAWINGS

Those skilled in the art will appreciate that elements in the figures are illustrated for simplicity and clarity and have not necessarily been drawn to scale. For example, the position or polarity of the electrodes, the dimensions and/or relative positioning of some of the elements in the figures may be exaggerated relative to other elements to help to improve understanding of various embodiments of the present invention. Also, common but well-understood elements that are useful or necessary in a commercially-feasible embodiment are often not depicted in order to facilitate a less obstructed view of these various embodiments of the present invention.

FIG. 1 is one example of a membrane electrodialysis system with pressure control via feed suction/pump location.

FIG. 2 is one example of a membrane electrodialysis system with pressure control via pump speed regulation.

FIG. 3 is one example of a membrane electrodialysis system with pressure control via a pressure control valve.

FIG. 4 shows a typical arrangement of the membranes and flow of solutions in a two chamber electrodialysis system.

FIG. 5 shows a typical arrangement of the membranes and flow of solutions in a three chamber electrodialysis system containing bipolar membranes.

### DETAILED DESCRIPTION

The present process ensures that, during electrodialysis, the product stream side, which has been freed of contaminants found in the feed stream, remains contaminant free in any working situation. If the electrodialysis (ED) unit malfunctions during operation (e.g., the membranes, fittings, or seals spring a leak, or the like), the product side maintains a hydrostatic pressure that is higher than that on the feed stream side through various modifications to the process. In the event that the unit experiences a power loss or other loss of motive forces (e.g., pump failure), both the modifications to the process and the higher elevation of the product maintains a higher pressure on the product side which keeps the feed stream solution from leaking into the product stream, thus maintaining and ensuring that the product stream will remain free of contaminants (i.e., lacking any amount of contaminant which would be objectionable or deleterious) from the feed stream.

Aqueous Solution. Aqueous feed stream solutions may contain an objectionable material of which it is desired to reduce the concentration. Aqueous feed stream solutions may also be mixed feed streams from which it is necessary to recover and concentrate a desirable material from a contaminated stream (the mixed feed stream). In both instances, the feed streams are referred to as being “contaminated” or containing a “contaminant.” Therefore, it is necessary to prevent the feed stream from passing into the clean, contaminant-free product side. Aqueous feed stream solutions that may be treated with the ED method include organic acids, bases, salts, or other useful products made or concentrated by ED. Some contaminants that may be present within the aqueous solutions in the feed stream include pathogenic bacteria, carbohydrates, allergenic proteins, microbes, undesirable ions, or certain other contaminants.

Membrane Electrodialysis. Membrane electrodialysis may be conducted using an anionic and a cationic membrane. The membranes are disposed between a cathode and anode and are subjected to an electrical field. The membranes form separate compartments and materials flowing through those compartments may be collected separately. One example of an electrodialysis apparatus containing ion-selective membranes is ED-1-BP (purchased from Electrolytica, Amherst, N.J.). Suitable membranes are available from Tokuyama (Japan).

In accordance with one aspect, an aqueous solution is contacted with the ion-selective membranes. Aqueous solutions may be processed in batch, semi-continuous, or continuous modes by contacting an aqueous solution with the ion-selective membranes and allowing the aqueous solution to flow through the membranes. When using batch, semi-continuous, or continuous modes, an electrical potential is applied across the anode and cathode for a time effective for recovering the desired electrodialyzed solution without contaminants and with the desired pH and ion concentrations. Processing times are a function of the number of ion-selective membranes that are used and the amount of electrical potential applied. Hence, resulting ED solutions can be monitored and further processed until a desired pH and/or ion concentration is achieved. Generally, an electrical potential of about 0.1 to about 25 volts per cell is provided across the anode and cathode electrodes.

In the figures, the feed stream enters the ED unit at its lower end at the left side and, as it passes through the membrane, only the clean, contaminant-free components are allowed to pass to the product side, located at the right side. The feed stream can be recycled as it exits the ED unit from the upper end at the left side. The product stream exits the ED unit from the top at the right side and is collected in a tank. The product stream can also be recycled back into the ED unit by reentering the ED unit from the bottom end of the unit at the right side.

Leaks in the seals, fittings, or membranes sometimes develop in ED systems for various reasons, such as the membranes become worn out or physically damaged, the ED unit malfunctions, or any other of a number of possible occurrences. In conventional ED systems, the feed stream solution can migrate or leak through a hole in the membrane and mix into the product stream. When this occurs, the product stream may become contaminated with the feed stream. The present invention prevents such contamination by maintaining a pressure gradient between the two sides such that the product side has a higher pressure than the feed stream side. Should a leak in a membrane or seal develop, the higher pressure on the product side prevents the feed stream from migrating into and contaminating the product stream. Of course, the higher pressure on the product side may cause some of the product stream to flow through the leaky membrane or seal and back into the feed stream. This “lost” product can be reprocessed once normal operation is resumed by passing through the membrane again on its way back to the product side.

It is important to note that in most cases, for example where a pinhole leak develops in a membrane, the operator is not aware of the problem and may continue running the unit under the false assumption that everything is operating properly. In conventional ED systems, a pinhole leak may go undetected for some time because the operation of the unit appears to be normal, yet the product stream may slowly become contaminated with the feed stream components. The present invention prevents such contamination even when a hole or a leak goes undetected and continues to protect the product stream from contamination from the feed stream. If a major leak develops (i.e., so that the pressure system also fails), it is more likely that the problem will be detected by the malfunctioning of the unit and the process may be shut down to correct the problem before the product stream becomes contaminated, or, if the product stream has already become contaminated, the product stream may be discarded or reprocessed before it is further distributed.

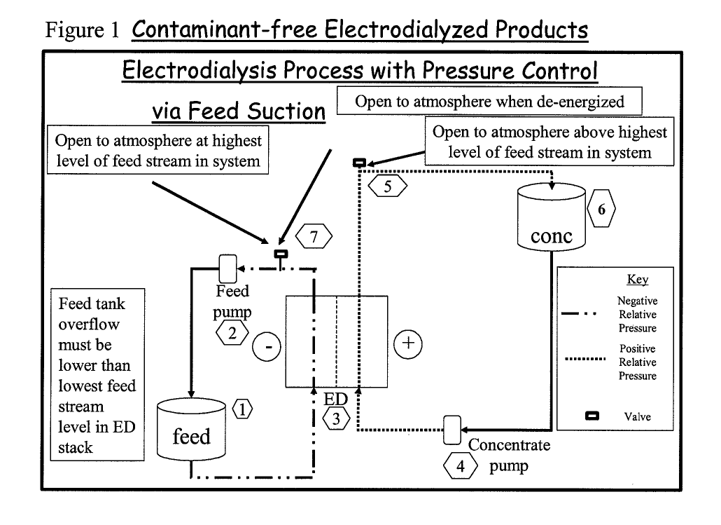

Electrodialysis Process. As shown in FIG. 1, the ED system consists of an ED unit 3 with a feed stream side (inlet stream) and a product stream side (contaminant-free product). The feed stream is the contaminated stream from which it is desired to recover a contaminant-free product. The feed stream consists of a feed tank 1, which feeds into the ED unit 3. The feed stream can be recycled as it exits the ED unit 3 at the opposite end and passes through a feed pump 2 before being sent back into the feed tank 1. The feed pump 2 may be a centrifugal pump (e.g., AC-3CP-MD from March Manufacturing, Inc., Glenview, Ill.). Also incorporated in the feed stream between ED unit 3 and pump 2 is valve 7, preferably the valve is an anti-siphon valve, and more preferably the valve is a solenoid-controlled anti-siphon valve, so designed as to be closed when energized (i.e., during normal operation) and to open the feed line to the atmosphere when de-energized. The product, or non-contaminated, side has a concentrate tank 6 which receives and holds the product stream that exits the ED unit 3 free of contaminants. The outlet of tank 6 is located at a higher elevation than the highest elevation of the feed stream in the system.

To maintain the continuous process, the product stream is fed back into the ED unit 3, passing first through a concentrate pump 4 and then into the ED unit 3. The concentrate pump 4 may also be a centrifugal pump of the same type used for the feed pump 2. The product stream that is downstream of the pump 4 is thus maintained at a higher pressure than the feed stream that enters/exits the ED unit. The pressure differential is automatically maintained in this manner by the relative location of pumps 2 and 4. The feed side of the ED unit 3 is under suction because the feed tank 1 is located below the ED unit 3. Pump 2 pulls feed solutions through the ED unit 3, while product is pushed through the ED unit 3 by pump 4, thus ensuring that the product side remains at a higher pressure. The anti-siphon valve 7 is open to the atmosphere when it is de-energized (i.e., when the process is shut down or in the event of an electrical failure), allowing feed solution to drain out of the unit; of course, the product should be isolated or removed from the system before intentionally being shut down.

The feed tank overflow (the top level of liquid in the tank) must be at a lower elevational point than the feed stream in the ED unit 3. Additionally, the highest elevational point in the feed stream line, which may be located before or after the feed pump 2, is open to the atmosphere through valve 7, which is closed when energized and open when de-energized. This allows feed material in the stack to freely drain out in the event of a loss of motive power or electricity. The feed pump 2 is located downstream from the ED stack. Turning to the product stream side, the concentrate pump 4 is located at the lowest level in the product stream system just before the stream enters the ED unit 3. The product stream line is also open to the atmosphere via valve 5, preferably a vacuum-breaker valve, at its highest point in the system, which is above the highest point in the feed stream system. A “vacuum-breaker” valve is a device containing an orifice which remains sealed when the pressure on the fluid side is greater than atmospheric pressure (e.g., when liquid is being pumped through the pipeline) but which freely opens and admits air into the pipeline when the fluid pressure is lower than atmospheric pressure, thus preventing the creation of a vacuum in the line. The opening to the atmosphere in the product stream line is closed during operation by pressure in the feed stream and opens when the pressure ceases (e.g., when the product pump is de-energized). The product stream side, by virtue of its elevation, is at least 1 psig higher than the feed side; preferably this pressure differential is about 1 psig to about 15 psig. This arrangement ensures a higher relative hydrostatic pressure on the product side in the presence or absence of motive or electrical power.

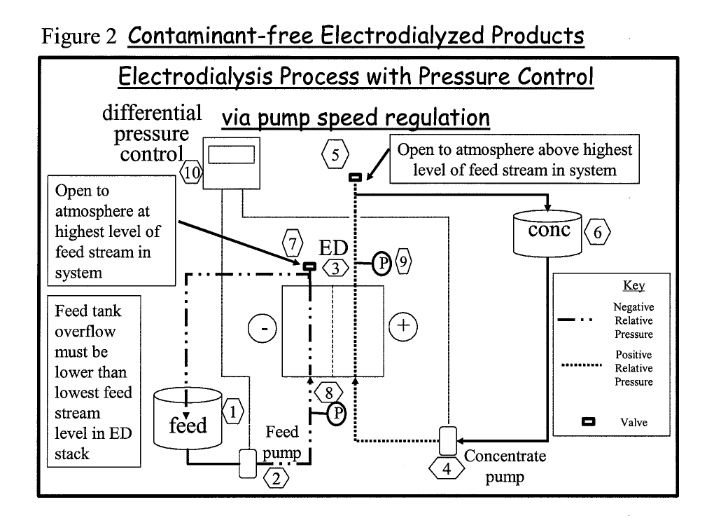

As shown in FIG. 2, the ED system is arranged similarly to the ED system of FIG. 1 (with the same reference numbers referring to similar aspects of the systems). The product stream side is the same as in FIG. 1 except that it has a pressure sensor 9 at its upper end just after the product stream exits the ED unit 3, where it will sense the lowest pressure in the product stream when the system is energized. The feed stream optionally may have feed pump 2 relocated to the bottom of the system just after the feed tank 1 but before the inlet to the ED unit 3. The line in the stream that is open to the atmosphere is still at the highest elevational point in the feed stream system but it is now located closer to the exit ED unit 3 and incorporates a valve 7. Preferably valve 7 is a vacuum-breaker valve. There is also a pressure sensor 8 located between the feed pump 2 and the stream inlet, which will sense the highest feed stream pressure in the system when the system is energized.

In this system, a differential pressure control device 10 is used to control the speeds of both the feed pump 2 and concentrate pump 4 in an effort to maintain the pressures as sensed by the pressure sensors, with the product side maintained at a higher pressure than the feed stream side.

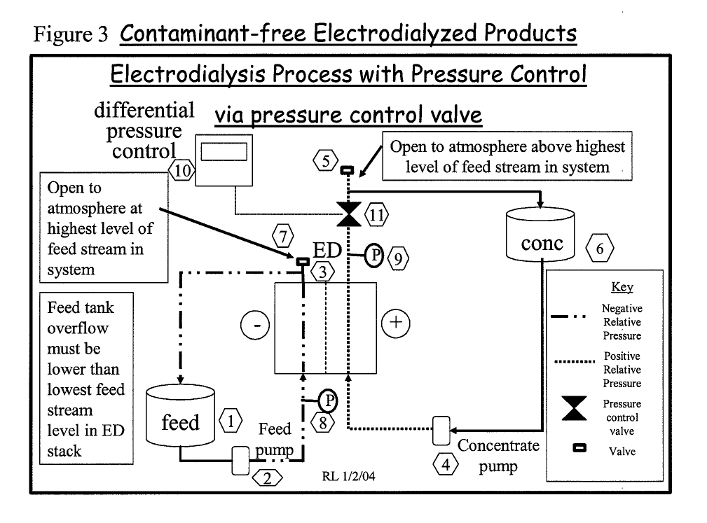

As shown in FIG. 3, the ED system is set up similarly to FIG. 2 (with the same reference numbers referring to similar aspects of the systems) except that the differential pressure control device 10 now controls a pressure control valve 11, preferably a throttling valve, located at the exit of the ED unit on the product stream line instead of controlling the speeds of the feed pump 2 and concentrate pump 4. The pressure control valve 11 is controlled by the differential pressure control device 10 such that the positive relative pressure on the product stream side is higher than the feed stream side when the system is energized.

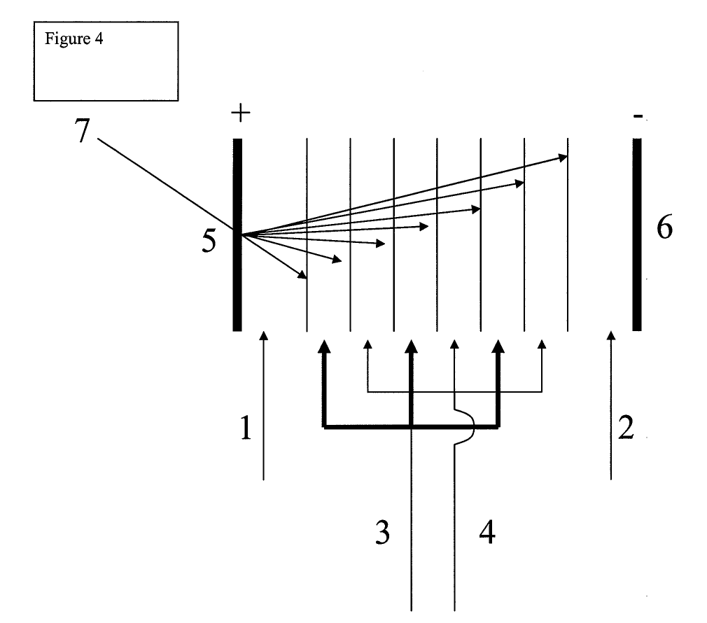

FIG. 4 shows a typical arrangement of the membranes and flow of solutions in a two chamber electrodialysis system. As shown in FIG. 4, electrodialysis works on the principle of having charged dialysis membranes 7, typically in alternating order, in-between electrodes where a current is drawn. The membranes 7 are positively charged, negatively charged, or bi-polar (both positively and negatively charged) in nature. Typically, ions flow from one chamber, called a feed, to another chamber, called a concentrate. Since the streams are typically in pairs, each set of feed and concentrate is called a cell pair. The current is drawn from the cathode 6 to the anode 5 with the negatively charged ions tending to move from right to left (toward the anode) and positively charged ions tending to move from left to right (toward the cathode).

In FIG. 4, for example, stream 3 is a feed stream while stream 4 is a concentrate stream. Two other streams make up a typical electrodialysis cell. These streams are called electrode rinses 1 and 2 and never make direct contact with either the feed stream 3 or concentrate stream 4 unless leakage occurs. It is common for electrode rinses 1 and 2 to come from the same container. In this case, simultaneous leaks between the electrode rinses 1 and 2 and both the feed stream 3 and concentrate stream 4 could result in contaminants in the feed stream 3 being transferred to the concentrate stream 4. For this reason, the electrode rinses 1 and 2, where it is adjacent to both the feed stream 3 and concentrate stream 4, must always be kept at a pressure at or below the concentrate pressure. This can be accomplished by operating the ED equipment with the same constraints and controls on the electrode rinse stream adjacent to the concentrate stream, as are imposed on the feed stream in all three control schemes described. Thus, even if contamination of the electrode rinses were to occur, there would be no possibility of contaminants flowing into the concentrate chamber because the pressure is at least one psig greater in the concentrate chamber.

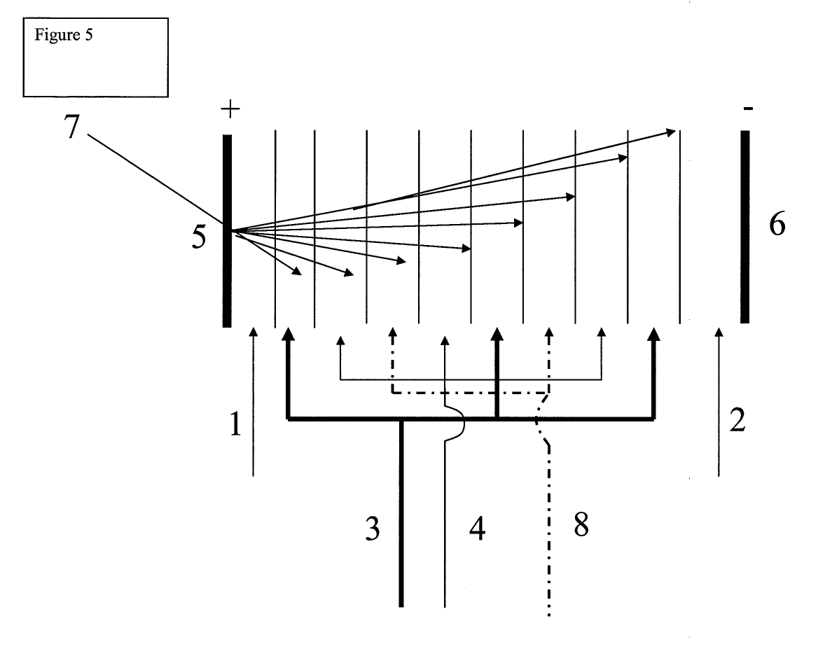

FIG. 5 shows a typical arrangement of the membranes and flow of solutions in a three chamber electrodialysis system containing bipolar membranes. The expanded configuration of electrodialysis shown in FIG. 5 works on the same principles as FIG. 4. The membranes 7 are positively charged, negatively charged, or bi-polar (both positively and negatively charged). Typically, ions flow from one chamber, called a feed chamber, to the other chambers, called concentrate and byproduct chambers. The streams are typically in sets and membranes 7 separate each stream. Each set of feed, byproduct, and concentrate chambers is called a cell. The current is drawn from the cathode 6 to the anode 5 with the negatively charged ions tending to move from right to (toward the anode) and the positively charged ions tending to move from left to right (toward the cathode).

In FIG. 5, for example, stream 3 could be a feed stream, stream 4 could be a concentrate stream, and stream 8 could be the byproduct stream. The pressure of the byproduct stream 8 would be set at or below the feed stream 3 if the byproduct stream contains contaminants. Otherwise, the byproduct stream 8 would be set at or below the concentrate stream 4 but above the feed stream 3 if the byproduct stream is contaminant free. As described above in reference to FIG. 4, two other streams make up a typical electrodialysis cell—electrode rinses 1 and 2, which never make direct contact with either the feed or concentrate streams unless leakage occurs.

The following examples illustrate methods for carrying out the invention and should be understood to be illustrative of, but not limiting upon, the scope of the invention which is defined in the appended claims.

### EXAMPLES

### Example 1

A simulated cheese whey permeate solution in which most, but not all, of the lactose has been fermented to lactic acid was “challenged” by the addition of bacterial amylase, which serves as a proxy for the less readily-detected beta lactoglobulin, a common allergenic protein. Lactate ion was then recovered from the solution first using an electrodialysis system in batch (recirculation) operating mode with intact membranes and secondly with the membranes intentionally pierced to create an opening or hole between the feed and product stream sides. A positive pressure of at least 1 psig was manually maintained on the recovery or product side. Recovered material (product/concentrate side) was tested for the presence of reducing sugars using Benedict's test and amylase using an ELISA method. Benedict's test generally has a detection sensitivity of ˜0.01% for reducing sugars and the amylase test has a detection sensitivity of about 2 units enzyme/kg for amylase. Neither reducing sugars nor amylase were detected in the recovered material.

The solution used in the feed stream was made up as follows: 1 L of tap water containing 40 g lactose, 144 g lactic acid (100%), and 40 g bacterial amylase (BAN 800 MG from Novozymes North America Inc., Franklinton, N.C.) was added to 8 L of tap water. The solution was then neutralized to a pH of about 6.0 using 20% sodium hydroxide solution. The resulting solution contained an enzyme equivalent of approximately 4000 units/kg.

The ED system used was essentially like that shown in FIG. 2. The electrodialysis equipment used was a Eurodia EUR 1 stack with Tokuyama AXE anionic monopolar membranes and Tokuyama CMX cationic monopolar membranes (1 cell). The unit was started at time (t)=0 minutes with only water circulating in the cleaned, intact system. Pressure on the recovery (product/concentrate) side was manually set at 1 psig higher than the feed/inlet side. A voltage of 10 volts was applied to the unit. When stable operation was obtained, the 1 L of water containing the enzyme was added to the feed/inlet stream. Streams were recirculated at approximately 3 liters/minute using AC-3CP-MD centrifugal pumps from March Manufacturing, Inc. (Glenview, Ill.). Recirculation and sampling continued for two hours.

After two hours, the second phase of testing began. The unit was cleaned and a 1 mm diameter hole was placed in the center of the anionic monopolar membrane so that the feed and product sides were in liquid communication with each other, and the unit was restarted and operated as above for an additional two hours.

Samples of the two streams, the feed and the recovery/product streams, were both taken at t=0 (i.e., before addition of the amylase solution). The feed stream was additionally sampled at t=10 and 120 minutes (i.e., after amylase addition). The recovery/product stream was additionally sampled at t=30, 60, 90, and 120 minutes (after amylase addition). The amylase and reducing sugars in both the feed stream and the recovered/product stream were measured. Amylase and reducing sugars were detected in the feed stream at all times after t=0. Benedict's tests for reducing sugars of the recovery/product stream were negative at all times, indicating that no reducing sugars were detected. The amylase assay of the recovery/product stream performed by fluorescence was below the detectable limit of 2 units enzyme/kg at all times in the recovery/product stream.

These results indicate that, despite a 1 mm diameter hole placed in the center of the anionic monopolar membrane, the higher pressure on the product stream side ensured that the feed stream could not leak through the hole in the membrane to contaminate the product stream.

Table:

EXAMPLE 1
Amylase Test Data

| | Description: | | | | | | | | | |
|---|---|---|---|---|---|---|---|---|---|---|
| | Feed | Feed | Feed | Electrode | Electrode | Product | Product | Product | Product | Product |
| | Solution | Solution | Solution | Rinse | Rinse | Solution | Solution | Solution | Solution | Solution |
| | 0 min | 15 min | 120 min | 0 min | 120 min | 0 min | 30 min | 60 min | 90 min | 120 min |
| Amylase | <2 | 4289.35 | 5307.24 | <2 | <2 | <2 | <2 | <2 | <2 | <2 |
| presence | | | | | | | | | | |
| (UNIT/KG) | | | | | | | | | | |

Note -
“Feed Solution 0 min” was water (before the addition of amylase).

### Example 2

Ultrafiltered acid cheese whey permeate provided by Kraft Foods was supplemented with 2% corn steep liquor and fermented with Lactobacillus rhamnosus in a batch reactor and continuously neutralized to pH 6.5 using 1N sodium hydroxide. The fermentation continued until essentially all the lactose had been converted to lactic acid and neutralized to about pH 6.5. The fermented whey permeate was microfiltered to remove bacterial cells and the sterile fermented whey permeate was then fortified with a high level of whey proteins using 50% whey protein concentrate (RT-50, DMV International). The fermented whey permeate with added whey protein was used as the feed stream. The product stream was (initially) tap water. The electrode rinse was 0.5 M Na₂SO₄. The fermented permeate was sampled before and after whey protein addition for protein assay.

The electrodialysis unit was set up according to the cell configuration (1 cell) as depicted in FIG. 2. As in Example 1, the membrane composition was anionic monopolar membranes (Tokuyama AXE), and cationic monopolar membranes (Tokuyama CMX). The pressure of the feed stream was set at 0.6 psig lower than the product stream and the electrode rinse at 0.4 psig lower than the feed stream to prevent osmotic transfer. The pump for each stream was turned on with the other pumps off to check the system for leaks.

Tap water was initially used as the product stream. The pump for the product stream was turned on and allowed to reach its set pressure. The DC power source was turned on and the system voltage set to 5 V. All of the pumps were turned on and the pressure of each stream was set as indicated above. The current was allowed to reach equilibrium.

The pH, conductivity, and temperature of each stream were measured and system energy transfer, voltage, and current were run at operating parameters for ten minutes to achieve stability.

The fermented whey with added whey protein was substituted as the feed stream.

Samples of the product stream were taken for analysis at time zero.

The system was then shut down. The intact membrane was replaced with a membrane containing a hole through it.

Steps 1-3 were repeated except the process was operated for two hours, after which a sample of the product stream was taken for analysis.

The process was restarted and the pressures of the feed and product streams were equalized. The process was operated for an additional two hours, after which another sample of the product stream was taken for analysis.

Samples analyzed (VERATOX® Milk Allergen ELISA method, Neogen Corp, Lansing, Mich.) included the fermented permeate before and after addition of whey protein, the product stream before and immediately after the addition of permeate to the feed stream, after two hours of operation with a pressurized product stream, and after two hours of operation without a pressurized product stream (negative control). Results clearly indicated the advantage of operating with the pressurized product stream:

| | Veratox result |
|---|---|
| | (Total milk |
| Sample description | allergen ppm) |
| Permeate without added WPC | <2.5 |
| Permeate with added WPC | 25 |
| Product stream before permeate addition | <2.5 |
| Product stream after permeate addition, with | <2.5 |
| pressurized product stream and perforated membrane | |
| Product stream after operating 2 hours with | <2.5 |
| pressurized product stream and perforated membrane | |
| Product stream after operating 2 hours without | 2.5 |
| pressurized product stream, with perforated membrane | |

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A contaminant-free electrodialysis method comprising:
contacting an aqueous feed stream containing at least one contaminant with a membrane electrodialysis system, the membrane electrodialysis system comprising at least one cationic membrane and at least one anionic membrane, a cathode electrode, and an anode electrode where the membranes are disposed between the cathode electrode and the anode electrode;
applying an electrical potential across the anode electrode and cathode electrode for a time effective for removing ionic, non-contaminated materials from the feed stream to form a product stream substantially free of the at least one contaminant, wherein the aqueous feed stream forms a feed stream side of the electrodialysis system and the product stream forms the product stream side of the electrodialysis system; and
wherein a pressure differential is maintained across the electrodialysis system such that the product stream side has a higher pressure than the feed stream side, and wherein the pressure differential is sufficient to prevent the at least one contaminant in the feed stream from entering the product stream to provide a contaminant-free product stream.

2. The method of claim 1 wherein the pressure differential is maintained such that the product stream side has a higher pressure than the feed stream side by positioning a feed tank overflow lower than the lowest level of product in the system.

3. The method of claim 1 wherein the pressure differential is maintained such that the product stream side has a higher pressure than the feed stream side by positioning the outlet of a product tank at a higher elevation than the highest elevation of the feed stream.

4. The method of claim 1 wherein the pressure differential is maintained such that the product stream side has a higher pressure than the feed stream side by positioning a highest point of the product stream side above a highest point of the feed stream side.

5. The method of claim 1 wherein the pressure differential is at least about 1 psig.

6. The method of claim 1 wherein the pressure differential is generated by maintaining a lower pressure on the feed stream side using a combination of feed and product pump positionings such that the feed pump is located downstream of the electrodialysis unit and the product pump is upstream of the electrodialysis unit and an anti-siphon valve is located on the feed stream side between the electrodialysis unit and feed pump and is open to the atmosphere when de-energized, while the product stream side maintains a positive pressure.

7. The method of claim 1 wherein the pressure differential is generated by maintaining a higher positive relative pressure on the product stream side using a differential pressure control device which controls the pumping speeds of a feed stream pump and a product stream pump.

8. The method of claim 1 wherein the pressure differential is generated by maintaining a higher positive relative pressure on the product stream side using a differential pressure control device which controls a pressure control valve located in the product stream.

9. The method of claim 1 wherein the contaminants found in the feed stream are selected from the group consisting of pathogenic bacteria, carbohydrates, allergenic proteins, microbes, and mixtures thereof.

10. The method of claim 1 wherein the aqueous solution for the feed stream is selected from the group consisting of organic acids, bases, salts, fermentates, reaction mixtures, brines, extracts, or mixtures thereof made or concentrated by electrodialysis.

11. A contaminant-free electrodialyzed composition prepared by a method comprising:
contacting an aqueous feed stream containing at least one contaminant with a membrane electrodialysis system, the membrane electrodialysis system including at least one cationic membrane and at least one anionic membrane, the membranes being disposed between a cathode electrode and an anode electrode;
applying an electrical potential across the anode and cathode for a time effective for removing ionic, non-contaminated materials from the feed stream to form a product stream substantially free of the at least one contaminant, wherein the aqueous feed stream forms a feed stream side of the electrodialysis system and the product stream forms the product stream side of the electrodialysis system; and
wherein a pressure differential is maintained across the electrodialysis system such that the product stream side has a higher pressure than the feed stream side, and wherein the pressure differential is sufficient to prevent the at least one contaminant in the feed stream from entering the product stream to provide a contaminant-free product stream.

12. The composition of claim 11 wherein the pressure differential is maintained such that the product stream side has a higher pressure than the feed stream side by positioning a feed tank overflow lower than the lowest level of product in the system.

13. The composition of claim 11 wherein the pressure differential is maintained such that the product stream side has a higher pressure than the feed stream side by positioning the outlet of a product tank at a higher elevation than the highest elevation of the feed stream.

14. The composition of claim 11 wherein the pressure differential is maintained such that the product stream side has a higher pressure than the feed stream side by positioning a highest point of the product stream side above a highest point of the feed stream side.

15. The composition of claim 11 wherein the pressure differential is at least about 1 psig.

16. The composition of claim 11 wherein the pressure differential is generated by maintaining a negative pressure on the feed stream side using a combination of feed and product pump positionings such that the feed pump is located downstream of the ED unit and the ED unit is downstream of the product pump and an anti-siphon valve is located on the feed stream side between the ED unit and feed pump and is open to the atmosphere when de-energized while the product stream side maintains a positive pressure.

17. The composition of claim 11 wherein the pressure differential is generated by maintaining a higher positive relative pressure on the product stream side using a differential pressure control device which controls the pumping speeds of a feed stream pump and a product stream pump.

18. The composition of claim 11 wherein the pressure differential is generated by maintaining a higher positive relative pressure on the product stream side using a differential pressure control device which controls a pressure control valve located in the product stream.

19. The composition of claim 11 wherein the contaminants found in the feed stream are selected from the group consisting of pathogenic bacteria, carbohydrates, allergenic proteins, microbes and mixtures thereof.

20. The composition of claim 11 wherein the aqueous solution for the feed stream is selected from the group consisting of organic acids, bases, salts, fermentates, reaction mixtures, brines, extracts, or mixtures thereof made or concentrated by electrodialysis.
